(19) United States
(12) Patent Application Publication
(10) Pub. No.: US 2018/0137592 A1
(43) Pub. Date: May 17, 2018

(54) SYSTEM, METHOD AND COMPUTER PROGRAM PRODUCT FOR OPTIMIZING THE SHIPMENT OF PRODUCTS

(71) Applicant: Jason C. Farber, Quebec (CA)

(72) Inventor: Jason C. Farber, Quebec (CA)

(21) Appl. No.: 15/813,531

(22) Filed: Nov. 15, 2017

Related U.S. Application Data
(60) Provisional application No. 62/422,349, filed on Nov. 15, 2016.

(51) Int. Cl. G06Q 50/28; G06Q 30/06

(52) U.S. Cl. CPC G06Q 50/28; G06Q 30/0641; G06Q 30/0635

(57) ABSTRACT

A computer implemented method and system, and computer program product, for optimizing the shipment of products. For example, the method may include receiving product identification information, which identifies a first product selected for purchase and shipment. Based on the received product selection information, the method may determine the specifications for the identified first product. Based on the determined product specifications, the method may generate shipping container information identifying a shipping container suitable for shipping the identified first product. Based on the identified shipping container, the method may generate information identifying at least a second product that fits in the identified shipping container along with the identified first product. The method also may include receiving information indicating that second product has been selected for purchase and shipment, and generating information indicating that the identified first product and the second product should be shipped to the purchaser in the identified shipping container.

### CROSS-REFERENCE TO RELATED APPLICATIONS

This application claims the benefit of U.S. Provisional Patent Application No. 62/422,349, filed Nov. 15, 2016.

### TECHNICAL FIELD OF THE INVENTION

The present application relates generally to the technical field of data processing and, in one specific example, to optimizing the shipment of products purchased via an online shopping platform and managing additional product recommendations to optimize the shipment of products.

### BACKGROUND OF THE INVENTION

Conventionally, after a consumer selects products for purchase from an online retailer, a shipping container is specified for shipping the selected products. Typically, the consumer is unaware of the size of the selected shipping container. A disadvantage of such conventional systems and methods is that, to the extent that the specified shipping container includes empty space, the empty space may be filled with packing material. Filling empty space with packing material, however, wastes valuable shipping space because the size of a shipping container can affect the shipping costs more than the weight of the container. Thus, what is needed is a system and method of shipping products purchased via an online retailer that does not have such disadvantages.

### BRIEF DESCRIPTION OF THE DRAWINGS

FIG. 1 illustrates an environment in which the product shipping optimization system and method may operate, according to some exemplary embodiments of the present invention.

FIG. 2 illustrates a logical diagram for a system for optimizing the shipment of products, according to some exemplary embodiments of the present invention.

FIG. 3 illustrates an exemplary user interface to an online shopping platform, according to some exemplary embodiments of the present invention.

FIG. 4 illustrates a flow chart for a method for optimizing the shipment of products, according to some exemplary embodiments of the present invention.

FIG. 5 illustrates a computer system for implementing exemplary embodiments of the present invention.

### DETAILED DESCRIPTION OF EXEMPLARY EMBODIMENTS

The following description is provided as an enabling teaching of embodiments of the invention including the best, currently known embodiment. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

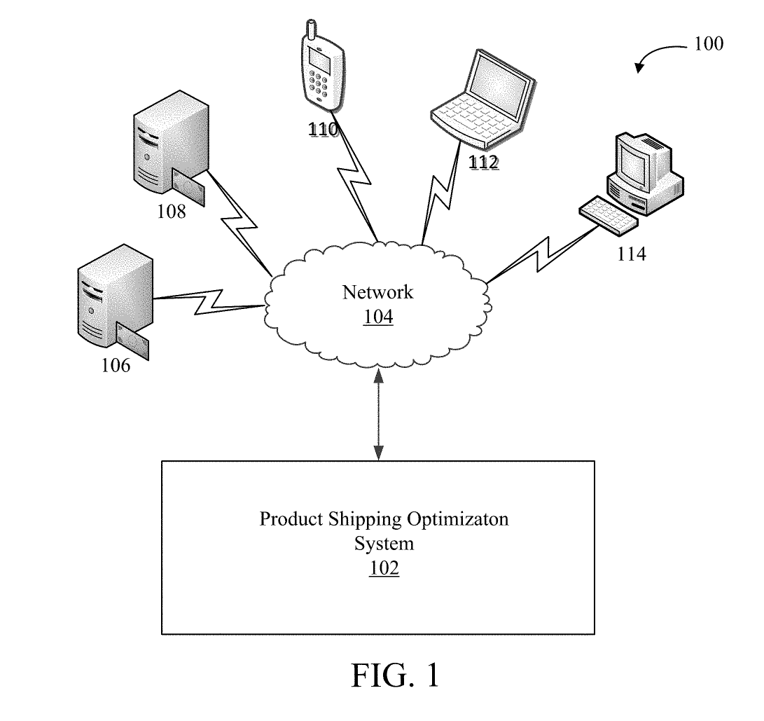

Exemplary embodiments of the system and method of the present disclosure may optimize the shipment of products. FIG. 1 illustrates an environment 100 in which the product shipping optimization system and method may operate, according to some exemplary embodiments of the present invention. As shown in FIG. 1, environment 100 may include a product shipping optimization system 102, which is in electronic communication with one or more online shopping platforms 106 and 108 via network 104. Online shoppers may access online shopping networks 106 and 108 through a mobile computing device 110, a laptop computer 112 or desktop computer 114. Exemplary online shopping platforms may include online marketplaces, such as amazon.com and ebay.com, as well as online shopping platforms associated with traditional brick and mortar retailers, such as Home Depot, Walmart, etc. The invention, however, is not limited to any particular online shopping platform. Also, the number of online shopping platforms and user devices shown in FIG. 1 are for illustration purposes only and the invention is not limited to any particular environment.

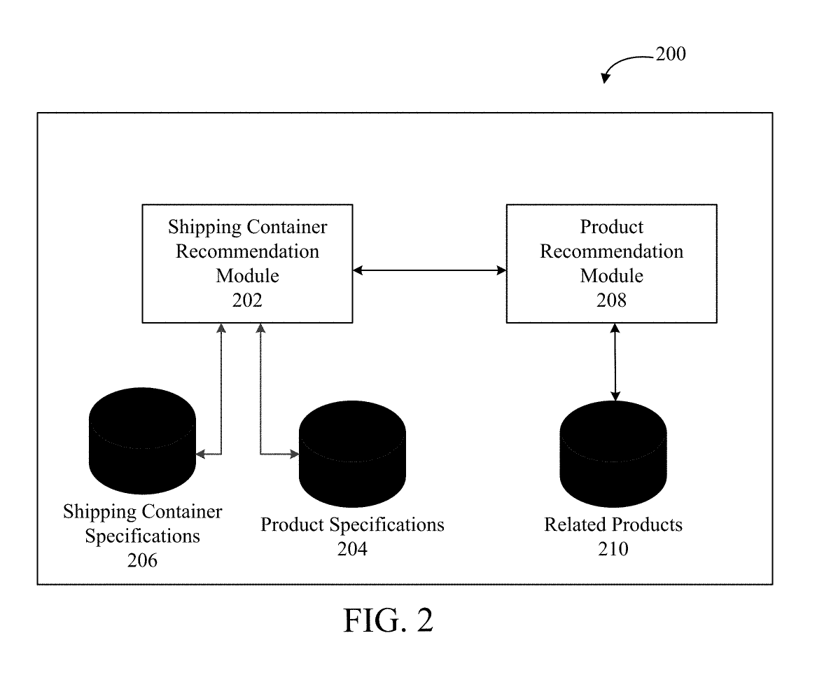

FIG. 2 is a logical diagram of a computer implemented product shipping optimization system 200, according to exemplary embodiments of the present invention. As shown in FIG. 2, the system 200 may comprise a shipping container recommendation module 202, a product specification database 204, a shipping container specification database 206, a product recommendation module 208, and a product recommendation database 210, all of which are in electronic communication with each other via the Internet and/or one or more wide area networks and/or local area networks.

Continuing with FIG. 2, the shipping container recommendation module 202 may receive product identification information, which identifies one or more products that a purchaser has selected for purchase and shipment. The shipping container recommendation module 202 may receive such product identification information via a user interface to an online shopping platform 104. Responsive to receiving the product identification information, the shipping container recommendation module 202 may access a product specification database 204. Product specification database 204 may store product specification information in association with product identification information for a plurality of products. Such product specification information may include product dimension information, which is information about the dimensions (height, length and width) of the plurality of products, as well as product weight information, which is information about the weight of the plurality of products.

The shipping container recommendation module 202 may access product dimension information and/or product weight information that is stored in the product specification database 204 in association with each of the products identified in the product identification information. Based at least in part on the product dimension information, the shipping container recommendation module 202 may generate shipping container recommendation information, which is information that identifies a shipping container that is suitable for shipping the products identified in the product identification information. The shipping container recommendation module 202 also may generate shipping container recommendation information at least in part based on product weight information. As may be appreciated, in some exemplary embodiments, the shipping container recommendation information may be generated by an online shopping platform. In other exemplary embodiments, shipping container recommendation information may be generated by the product manufacturer, or a shipper that has contracted with the online shopping platform to provide shipping services. In still other exemplary embodiments, the purchaser may specify a shipping container for shipping products purchased.

Based on the shipping container recommendation information, system 200 may access shipping container specification information, which may also be stored in the shipping container specification database 206. The shipping container specification database 206 may include shipping container specification information for a plurality of shipping containers. Shipping container specification information may include shipping container dimension information and shipping container weight information for a plurality of shipping containers. Shipping container dimension information may include information about the dimensions (height, length and width), and shipping container weight information may include information about the maximum weight, of a plurality of products.

Based on the product identification information and the shipping container specification information, a product recommendation module 108 may determine if there is room in the specified shipping container to ship additional products. Commercially available cube calculation software, such as TOPS® Pro carton optimization software, available from TOPS Software Corporation of Allen, Tex., may be used to determine if the specified shipping container has room for additional products. As may be appreciated, such additional products may be shipped to the purchaser with the products already selected for purchase at little or no additional shipping cost.

If product recommendation module 108 determines that there is room in the specified shipping container to ship additional products, product recommendation module 108 may generate additional product recommendation information. The additional product recommendation information may include information identifying one or more products that are related to the products already selected for purchase and that also could be shipped in the identified shipping container along with the product already selected for purchase.

In some exemplary embodiments, system 200, and product recommendation module 108, may access a related product database 210 to identify one or more products that are related to the products already purchased, or selected for purchase, by a purchaser. A product may be related to a product already selected for purchase if the product was previously purchased by the purchaser. A product also may be related to the product already selected for purchase if the product has been purchased, by the purchaser or by others, at the same time as the product already selected. A product also may be related to the product already selected for purchase if the product has been considered for purchase, by the purchaser or by others, at the same time as the product already selected for purchase. Other methods of determining whether a product is related to a product already selected for purchase are within the scope of the present invention.

Such embodiments have several advantages including, additional revenue for online retailers from sales of additional recommended products. Another advantage for online retailers that pay for shipping is a reduction of shipping costs as a percentage of revenue by more efficiently utilizing what would otherwise be empty space in a specified shipping container, or by recommending additional product purchases and a larger shipping container. Advantages to online consumers include being able to purchase additional products for little or no additional cost shipping costs.

In some exemplary embodiments, system 200 may determine that the selected shipping container does not have room for additional products. In that case, system 200 may make additional product recommendations that consist of one or more related products that will not fit in the specified shipping containers. Such additionally recommended products may be identified and the additional shipping costs also may be specified. Since such additionally recommended products do not fit in the specified shipping container, if they are selected by the consumer, a larger shipping container may be specified. In that case, the additional cost of the larger shipping container may be displayed.

In some exemplary embodiments, additional recommended products that do fit in the specified shipping container, and do not increase shipping costs if selected by a consumer, may be identified by any suitable designation, such as an asterisk or retailer logo. In other exemplary embodiments, additional recommended products that do not fit in the specified shipping container, and that do increase shipping costs if selected by a consumer, may be identified by any suitable designation, such as notation as to the additional shipping costs, e.g., “Product No. 1234 ships for an additional $1.00.”

In the event that a larger shipping container is specified because the consumer has selected additional recommended products that do not fit in the originally specified shipping container, then the system and method of the present invention would again determine if there is any free space in the larger shipping container and, if so, make additional recommendations for products that would fit in the free space.

In some exemplary embodiments, system 200 may generate information recommending purchasing an optional storage container for both shipping and storage of purchased products. The size of the recommended storage container may be determined based on the products that have been selected for purchase. Again, commercially available cube calculation software may be used to determine if recommended storage container has room for additional products, and, if so, system 100 may recommend additional related products that would also fit into the recommended storage container. As may be appreciated, the cost of shipping such storage containers is generally prohibitively expensive. Thus, an advantage of this embodiment is that the storage container may be purchased and shipped more cost effectively to the consumer because other products, which will also fit into the selected storage container, are being shipped a little or no additional cost. Another advantage of this embodiment is that packaging waste is eliminated because the products are being shipped in a reusable storage container, rather than disposable shipping containers. An advantage to the online retailer and the manufacturer of the storage containers is additional sales.

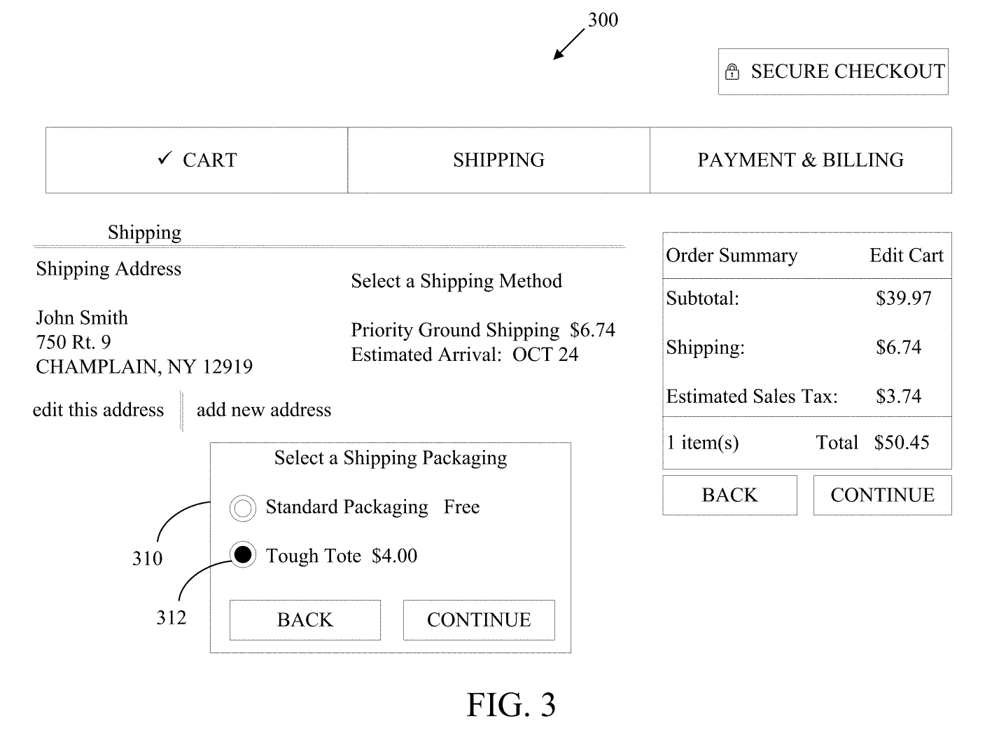

FIG. 3 illustrates an exemplary user interface 300 to an online shopping platform, according to some exemplary embodiments of the present invention. As discussed above in connection with FIG. 2, system 200 may recommend that an online shopper purchase a storage container for purposes of shipping products already selected by an online consumer. In an exemplary embodiment, user interface 300 may include an area 310, where a storage container is recommended to the online shopper. Interface 300 also may include a means for the online shopper to select the recommended storage container for purchase. In an exemplary embodiment, interface 300 may provide a radio button 312, whereby an online shopper can select the recommended storage container.

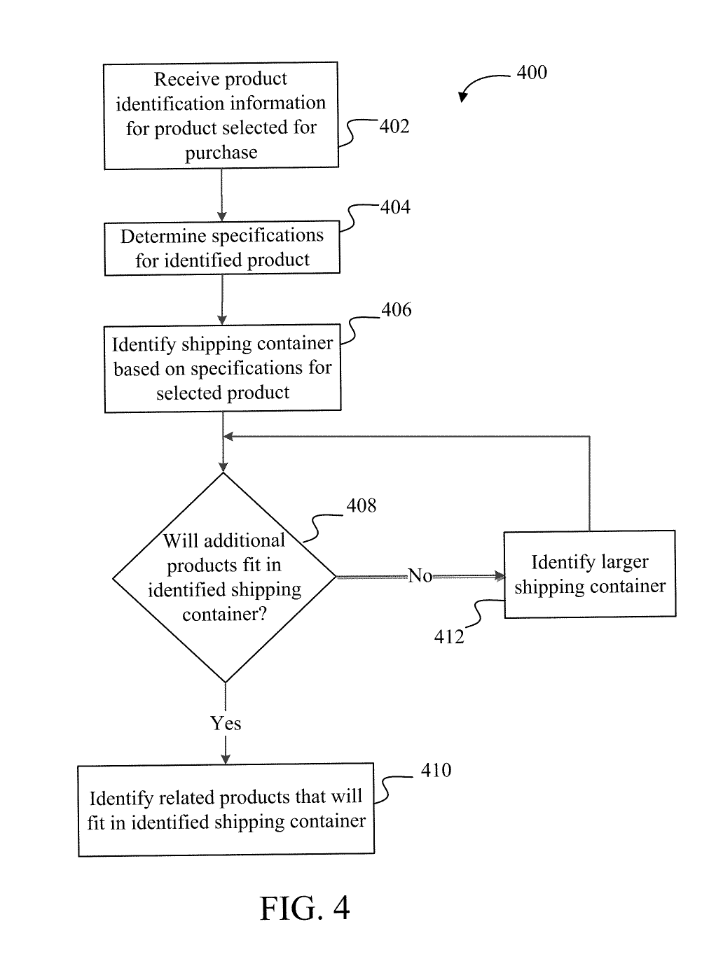

FIG. 4 is a flowchart illustrating a process 400 for optimizing the shipment of products, according to an exemplary embodiment. As shown in FIG. 4, in operation 402, process 400 receives product identification information. Product identification information is information identifying a first product selected for purchase and shipment. Processing control may then be transferred to operation 404.

In operation 404, based on the received product identification information, method 400 determines the product specifications for the identified first product. The product specifications may be determined by accessing a data store containing product specification information stored in association with product identification information for a plurality of products. Processing control may then be transferred to operation 406.

In operation 406, based on the determined product specifications for the identified first product, method 400 generates shipping container information. The generated shipping container information includes information identifying a shipping container suitable for shipping the identified first product. The shipping container information is based on the received product selection information and the product specifications for the product identified in the received product selection information. In some exemplary embodiments, the shipping container information is received from the purchaser of the identified first product, the seller of the identified first product or a shipper of the identified first product. Processing control may then be transfer to operation 408.

In operation 408, method 400 determines whether additional products will fit in the identified shipping container along with the first identified product. If method 400 determines that additional products will fit in the identified shipping container along with the first identified product, processing control may then be transferred to operation 410

In operation 410, method 400 may generate information identifying at least a second product that fits in the identified shipping container along with the identified first product. In response to generating information identifying the second product that fits in the identified shipping container with the first identified product, method 400 may receive information indicating that the second product has been selected for purchase and shipment. In response to receiving information indicating that the second product has been selected for purchase and shipment, process 400 may generate information indicating that the identified first product and the second product should be shipped to the purchaser in the identified shipping container.

In some exemplary embodiments, the second product may be related to the identified first product. The second product may be related to the first product because the second product was previously purchased by the purchaser. In other embodiments, the second product may be related to the first product if it was purchased by another purchaser that also purchased the identified first product, or was considered by another purchaser that also considered purchasing the identified first product.

Returning to operation 408, if method 400 determines that additional products will not fit in the identified shipping container along with the first identified product, processing control may then be transferred to operation 412.

In operation 412, process 400 may identify a larger shipping container for shipping the identified first product. Processing control may then be returned to operation 408.

In some exemplary embodiments, method 400 may display storage container information that is comprised of information identifying a storage container that is also suitable for shipping the identified first product and the second product. In the event that process 400 receives information indicating that the purchaser has selected the identified storage container for purchase, process 400 may generate information indicating that the identified first product and the second product should be shipped to the purchaser in the identified storage container. Method 400 also may, based on the identified storage container, generate information identifying at least a third product, which will fit in the identified storage container along with the identified first product and the second product. The method 400 also may receive information indicating that a third product has been selected for purchase and shipment, and then generate information indicating that the identified first product, the second product, and the third product should be shipped to the purchaser in the identified storage container.

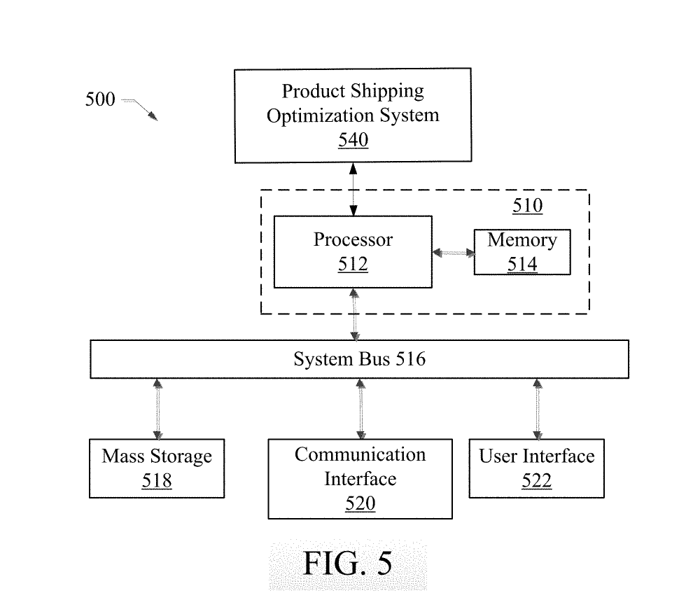

FIG. 5 is a diagram of an example computing system 500 that may be used to implement some example embodiments of the product shipping optimization system and method disclosed above. The computing system 500 may be implemented on any computing device or plurality of computing devices that may be configured to implement one or more example embodiments.

The computing system may include a plurality of elements, such as processing circuitry 510, storage 518, communication interface 520, and user interface 522, which may be interfaced via a system bus 516. It will be appreciated that the components, devices or elements illustrated in and described with respect to FIG. 5 below may not be mandatory and thus some may be omitted in certain embodiments. Additionally, the computing system 500 of some embodiments may include further or different components, devices or elements beyond those illustrated in and described with respect to FIG. 5.

Further, while FIG. 5 illustrates an architecture including elements interfaced via the system bus 516, it will be appreciated that in some example embodiments, elements of the computing system 500 may be implemented in a distributed computing environment in which elements may be distributed across a plurality of computing devices, which may be in communication with each other, such as via a network, to provide functionality of the computing system 500. As such, in some example embodiments, elements of the computing system 500 may be communicatively coupled via a network in addition to or in lieu of the system bus 516.

Some example embodiments may be implemented using an operating system for mobile devices, such as iOS or Android. Other exemplary embodiments may be implemented in an operating system(s), such as MICROSOFT WINDOWS™, UNIX™, LINUX™, IBM z/OS™, CISCO™ INTERNETWORK OPERATING SYSTEM™ (IOS), CISCO™ CATALYST™ OPERATING SYSTEM (CatOS), CISCO NX-OS, EMC™ ISILON OneFS™ OPERATING SYSTEM, NETAPP™ DATA ONTAP™, or other known operating system. It should be appreciated, however, that in some embodiments, one or more aspects of the computing system 500 may be implemented on and/or integrated with a virtualized computing system, such as may be provided by a converged infrastructure.

In some example embodiments, the computing system 500 may include processing circuitry 510 that is configurable to perform actions in accordance with one or more example embodiments disclosed herein. In this regard, the processing circuitry 510 may be configured to perform and/or control performance of one or more functionalities for a product shipping optimization system and method, in accordance with various example embodiments. Thus, the processing circuitry 510 may be configured to perform data processing, application execution and/or other processing and management services according to one or more example embodiments.

In some example embodiments, the processing circuitry 510 may include a processor 512 and, in some embodiments, such as that illustrated in FIG. 5, may further include memory 514. The processing circuitry 510 may be in communication with (e.g., via system bus 516) and/or otherwise control storage 518, communication interface 520, and/or user interface 522.

The processor 512 may be embodied in a variety of forms. For example, the processor 512 may be embodied as various hardware processing means such as a microprocessor, a coprocessor, a general purpose processor, a controller or various other computing or processing devices including integrated circuits (e.g., a logic device), such as an ASIC (application specific integrated circuit), an FPGA (field programmable gate array), some combination thereof, or the like. Although illustrated as a single processor, it will be appreciated that the processor 512 may comprise a plurality of processors. The plurality of processors may be in operative communication with each other and may be collectively configured to perform one or more functionalities to support determination of a configuration of a converged infrastructure in accordance with various embodiments. In some embodiments in which the computing system 500 is embodied as a plurality of computing devices, a plurality of processors, which may collectively form the processor 512, may be distributed across a plurality of computing devices that may be in operative communication with each other directly and/or via a network. In some example embodiments, the processor 512 may be configured to execute instructions that may be stored in a memory, such as the memory 514 and/or the storage 518 and/or that may be otherwise accessible to the processor 512. As such, whether configured by hardware or by a combination of hardware and software, the processor 512 may be capable of performing operations according to various embodiments while configured accordingly.

In embodiments including the memory 514, the memory 514 may include read only memory (ROM), random access memory (RAM), and/or the like. The storage 518 may include one or more memory and/or other storage devices, which may include fixed (e.g., a fixed hard disc drive, storage array, fixed flash memory device, and/or the like) and/or removable memory devices (e.g., a floppy disc drive, a removable flash memory device, an optical disc drive, and/or other removable memory device). The storage 518 may provide a persistent data storage device. In some example embodiments, the storage 518 may be configured to provide a backup storage. The storage 518 may include a memory device implemented locally to the computing system 500 and/or a memory device remote to the computing system 500, which may be communicatively coupled with the computing system 500, such as via a network. In some embodiments in which the computing system 500 is embodied as a plurality of computing devices, the memory 514 and/or storage 518 may include a plurality of memory devices, which may be distributed across a plurality of computing devices that may be in operative communication with each other directly and/or via a network to form the computing system 500.

In some embodiments, the memory 514 and/or the storage 518 may provide a non-transitory computer-readable storage medium that may store computer program instructions that may be executed by the processor 512. In this regard, the memory 514 and/or storage 518 may be configured to store information, data, applications, instructions and/or the like for enabling the computing system 500 to carry out various functions in accordance with one or more example embodiments. Applications that may be executed by the processor 512 may also be in the form of modulated electronic signals that may be accessed via a network modem or other network interface of the computing system 500.

The computing system 500 may further include a communication interface 520. The communication interface 520 may enable the computing system 500 to communicate (e.g., over a network or other communication interface) with another computing device or system. In this regard, the communication interface 520 may include one or more interface mechanisms for enabling communication with other devices and/or networks. As such, the communication interface 520 may include, for example, an antenna (or multiple antennas) and supporting hardware and/or software for enabling communications with a wireless communication network (e.g., a cellular network, wireless local area network, and/or the like) and/or a communication modem or other hardware/software for supporting communication via cable, digital subscriber line (DSL), USB, FireWire, Ethernet, one or more optical transmission technologies, and/or other wireline networking methods.

In some example embodiments, the computing system 500 may include the user interface 522. It will be appreciated, however, that in some example embodiments, one or more aspects of the user interface 522 may be omitted, and in some embodiments, the user interface 522 may be omitted entirely. The user interface 522 may be in communication with the processing circuitry 510 to receive an indication of a user input and/or to provide an audible, visual, mechanical, or other output to a user. As such, the user interface 522 may include, for example, a keyboard, a mouse, a joystick, a display, a touch screen display, a microphone, a speaker, one or more biometric input devices, and/or other input/output mechanisms.

As shown in FIG. 5, in some example embodiments, a product shipping optimization system 540 interfaces with computing system 500. As discussed above, the system 540 may be configured to optimize the shipping of products.

Embodiments described herein may be practiced with various computer system configurations including blade devices, cloud systems, converged infrastructure systems, rack mounted servers, switches, storage environments, hand-held devices, tablets, microprocessor systems, microprocessor-based or programmable consumer electronics, minicomputers, mainframe computers and the like. Some embodiments may also be practiced in distributed computing environments where tasks are performed by remote processing devices that are linked through one or more networks, such as one or more wireline networks and/or one or more wireless networks.

A computer program product may be used to implement the system described above, in some example embodiments. A computer program product embodiment may include a machine-readable, non-transitory (non-volatile) storage medium (media) having instructions stored thereon/in, which can be used to program a computer to perform any of the processes of the embodiments described herein. Computer code for operating and configuring a product shipping optimization system is preferably downloaded and stored on a hard disk, although the entire program code, or portions thereof, may also be stored in any other volatile or non-volatile memory medium or device as is well known, such as a read only memory (ROM) or random access memory (RAM), or provided on any media capable of storing program code, such as any type of rotating or solid state media, or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g. extranet, virtual private network (VPN), local area network (LAN), etc.) using any communication medium and protocols (e.g. transmission control protocol/internet protocol (TCP/IP), hypertext transport protocol (HTTP), HTTP secure (HTTPS), Ethernet, etc.) as are well known. It may be appreciated that computer code for implementing embodiments of the present invention can be implemented in any programming language that can be executed on a client system and/or server or server system such as, for example, C, C++, hypertext markup language (HTML), any other markup language, Java™, JavaScript, ActiveX, any other scripting language, such as VBScript, and many other programming languages as are well known may be used.

Many modifications and other embodiments of the invention set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

What is claimed is:

1. A computer implemented method for optimizing shipping of products, the method comprising:
receiving product identification information, the product identification information comprising information identifying a first product selected for purchase and shipment;
based on the received product selection information, determining the specifications for the identified first product;
based on the determined product specifications, generating shipping container information, wherein the shipping container information is comprised of information identifying a shipping container suitable for shipping the identified first product;
based on the identified shipping container, generating information identifying at least a second product, wherein the identified second product is a product that fits in the identified shipping container along with the identified first product;
receiving information indicating that second product has been selected for purchase and shipment; and
generating information indicating that the identified first product and the second product should be shipped to the purchaser in the identified shipping container,
wherein at least one operation is performed by a processor.

2. The method of claim 1, wherein the shipping container information is received from one of a purchaser of the identified first product, a seller of the identified first product and a shipper of the identified first product.

3. The method of claim 1, wherein the second product is at least one of:
a. related to the identified first product;
b. related to another product in the purchaser's online shopping cart;
c. previously purchased by the purchaser;
d. was purchased by another purchaser that also purchased the identified first product; and
e. was considered by another purchaser that also considered purchasing the identified first product.

4. The method of claim 1, further comprising:
displaying storage container information, wherein the storage container information is comprised of information identifying a storage container that is also suitable for shipping the identified first product and the second product.

5. The method of claim 4, further comprising:
receiving information indicating that the purchaser has selected the identified storage container for purchase; and
generating information indicating that the identified first product and the second product should be shipped to the purchaser in the identified storage container.

6. The method of claim 5, further comprising:
based on the identified storage container, generating information identifying at least a third product, wherein the identified third product is a product that fits in the identified storage container along with the identified first product and the second product;
receiving information indicating that third product has been selected for purchase and shipment; and
generating information indicating that the identified first product, the second product and the third product should be shipped to the purchaser in the identified storage container.

7. A computer implemented system for optimizing shipping of products, the system comprising:
at least one processor; and
at least one memory storing computer program code, wherein the at least one memory and stored computer program code are configured, with the at least one processor, to cause the system to at least:
receive product identification information, the product identification information comprising information identifying a first product selected for purchase and shipment;
based on the received product selection information, determine the specifications for the identified first product;
based on the determined product specifications, generate shipping container information, wherein the shipping container information is comprised of information identifying a shipping container suitable for shipping the identified first product;
based on the identified shipping container, generate information identifying at least a second product, wherein the identified second product is a product that fits in the identified shipping container along with the identified first product;
receive information indicating that a second product has been selected for purchase and shipment; and
generate information indicating that the identified first product and the second product should be shipped to the purchaser in the identified shipping container, wherein at least one operation is performed by a processor.

8. The system of claim 7, wherein the shipping container information is received from one of a purchaser of the identified first product, a seller of the identified first product and a shipper of the identified first product.

9. The system of claim 7, wherein the second product is at least one of:
a. related to the identified first product;
b. related to another product in the purchaser's online shopping cart;
c. previously purchased by the purchaser;
d. was purchased by another purchaser that also purchased the identified first product; and
e. was considered by another purchaser that also considered purchasing the identified first product.

10. The system of claim 7, wherein the at least one memory and stored computer program code are configured, with the at least one processor, to further cause the system to at least:
display storage container information, wherein the storage container information is comprised of information identifying a storage container that is also suitable for shipping the identified first product and the second product.

11. The system of claim 10, wherein the at least one memory and stored computer program code are configured, with the at least one processor, to further cause the system to at least:
receive information indicating that the purchaser has selected the identified storage container for purchase; and
generate information indicating that the identified first product and the second product should be shipped to the purchaser in the identified storage container.

12. The system of claim 11, wherein the at least one memory and stored computer program code are configured, with the at least one processor, to further cause the system to at least:
based on the identified storage container, generate information identifying at least a third product, wherein the identified third product is a product that fits in the identified storage container along with the identified first product and the second product;
receive information indicating that a third product has been selected for purchase and shipment; and
generate information indicating that the identified first product, the second product and the third product should be shipped to the purchaser in the identified storage container.

13. A computer program product for optimizing the shipment of products, the computer program product comprising at least one non-transitory computer-readable storage medium having program instructions stored thereon, which when executed by at least one processor, causes the at least one processor to perform a method comprising:
receiving product identification information, the product identification information comprising information identifying a first product selected for purchase and shipment;
based on the received product selection information, determining the specifications for the identified first product;
based on the determined product specifications, generating shipping container information, wherein the shipping container information is comprised of information identifying a shipping container suitable for shipping the identified first product;
based on the identified shipping container, generating information identifying at least a second product, wherein the identified second product is a product that fits in the identified shipping container along with the identified first product;
receiving information indicating that second product has been selected for purchase and shipment; and
generating information indicating that the identified first product and the second product should be shipped to the purchaser in the identified shipping container, wherein at least one operation is performed by a processor.

14. The computer program product of claim 13, wherein the shipping container information is received from one of a purchaser of the identified first product, a seller of the identified first product and a shipper of the identified first product.

15. The computer program product of claim 13, wherein the second product is at least one of:
a. related to the identified first product;
b. related to another product in the purchaser's online shopping cart;
c. previously purchased by the purchaser;
d. was purchased by another purchaser that also purchased the identified first product; and
e. was considered by another purchaser that also considered purchasing the identified first product.

16. The computer program product of claim 13, wherein the at least one non-transitory computer-readable storage medium causes the at least one processor to perform a method further comprising:
displaying storage container information, wherein the storage container information is comprised of information identifying a storage container that is also suitable for shipping the identified first product and the second product.

17. The computer program product of claim 16, wherein the at least one non-transitory computer-readable storage medium causes the at least one processor to perform a method further comprising:
receiving information indicating that the purchaser has selected the identified storage container for purchase; and
generating information indicating that the identified first product and the second product should be shipped to the purchaser in the identified storage container.

18. The computer program product of claim 17, wherein the at least one non-transitory computer-readable storage medium causes the at least one processor to perform a method further comprising:
based on the identified storage container, generating information identifying at least a third product, wherein the identified third product is a product that fits in the identified storage container along with the identified first product and the second product;
receiving information indicating that third product has been selected for purchase and shipment; and
generating information indicating that the identified first product, the second product and the third product should be shipped to the purchaser in the identified storage container.
